(19) United States
(12) Patent Application Publication
(10) Pub. No.: US 2026/0329064 A1
(43) Pub. Date: Oct. 22, 2026

(54) FOCUSING METHOD, MICROSCOPY SYSTEM, AND COMPUTER-READABLE STORAGE MEDIUM

(71) Applicants: GENEMIND BIOSCIENCES COMPANY LIMITED, Shenzhen (CN); NANJING GENEMIND BIOSCIENCES COMPANY LIMITED, Nanjing (CN)

(72) Inventors: Linsen LI, Shenzhen (CN); Chengwei LI, Shenzhen (CN); Jianfeng XU, Shenzhen (CN)

(73) Assignees: GENEMIND BIOSCIENCES COMPANY LIMITED, Shenzhen (CN); NANJING GENEMIND BIOSCIENCES COMPANY LIMITED, Nanjing (CN)

(21) Appl. No.: 19/529,026

(22) Filed: Feb. 3, 2026

(30) Foreign Application Priority Data
Feb. 19, 2025 (CN) 202510186977.5

(51) Int. Cl. G02B 21/24; G02B 21/26

(52) U.S. Cl. CPC G02B 21/242; G02B 21/244; G02B 21/26

(57) ABSTRACT

Disclosed are a focusing method, a microscopy system, and a computer-readable storage medium. The microscopy system includes an objective lens and an imaging assembly for imaging a target surface, and the focusing method includes: controlling the microscopy system to perform a coarse focusing operation such that a focusing position is at a coarse focusing position, the focusing position being a relative position between the objective lens and the target surface; controlling the objective lens and/or the target surface to move for multiple times near the coarse focusing position, and acquiring, after each movement, a new focusing position and a definition score of an image captured by the imaging assembly for the target surface corresponding to the new focusing position; and determining a definition mapping curve based on the plurality of focusing positions and the plurality of definition scores, and moving the objective lens and/or the target surface to enable the focusing position to be at a fine focusing position, such that the imaging assembly acquires a clear image of the target surface, the definition score at the fine focusing position being determined based on a peak of the definition mapping curve. The above focusing method helps improve the observation efficiency.

### CROSS-REFERENCE TO RELATED APPLICATIONS

This application claims the priority benefit of Chinese application serial No. 202510186977.5 filed on Feb. 19, 2025, the entirety of which is hereby incorporated by reference herein and made a part of the specification.

### TECHNICAL FIELD

The present disclosure relates to the technical field of focusing, and in particular, to a focusing method, a microscopy system, and a computer-readable storage medium.

### BACKGROUND OF THE INVENTION

In the related art, the focusing mode of the microscope is mainly optical focusing, and in the actual observation process, it may be necessary to adjust the focal plane of the objective lens for multiple times according to the observation requirements. Since the optical focusing has a large focusing duration and has the problem of inaccurate focusing, it may be necessary to focus again, which will greatly affect the observation efficiency.

### SUMMARY

The present disclosure provides a focusing method, a microscopy system, and a computer-readable storage medium to solve at least one of the above technical problems.

Disclosed is a focusing method applied to a microscopy system. The microscopy system includes an objective lens and an imaging assembly for imaging a target surface. The focusing method includes:
controlling the microscopy system to perform a coarse focusing operation such that a focusing position is at a coarse focusing position, the focusing position being a relative position between the objective lens and the target surface; and
controlling the microscopy system to perform a fine focusing operation, including:
controlling the objective lens and/or the target surface to move for multiple times near the coarse focusing position, and acquiring, after each movement, a new focusing position and a definition score of an image captured by the imaging assembly for the target surface corresponding to the new focusing position; and
determining a definition mapping curve based on the plurality of focusing positions and the plurality of definition scores, and moving the objective lens and/or the target surface to enable the focusing position to be at a fine focusing position, such that the imaging assembly acquires a clear image of the target surface, the definition score at the fine focusing position being determined based on a peak of the definition mapping curve.

In the above focusing method, a new focusing position and a corresponding definition score are obtained by moving the objective lens and/or the target surface, and then a plurality of focusing positions and a plurality of definition scores are obtained. The plurality of definition scores may be used to determine the definition mapping curve, and the focusing position corresponding to the peak of the definition mapping curve can enable the imaging assembly to acquire the clearest image, so that the focusing operation of the microscopy system is controlled by the change condition of the definition score, thereby achieving an automatic focusing effect, making the focusing more accurate and faster, and improving the observation efficiency.

Disclosed is a microscopy system. The microscopy system includes an objective lens, an imaging assembly for imaging a target surface, and a control module. The control module is configured for:
controlling the microscopy system to perform a coarse focusing operation such that a focusing position is at a coarse focusing position, the focusing position being a relative position between the objective lens and the target surface; and
controlling the microscopy system to perform a fine focusing operation, including:
controlling the objective lens and/or the target surface to move for multiple times near the coarse focusing position, and acquiring, after each movement, a new focusing position and a definition score of an image captured by the imaging assembly for the target surface corresponding to the new focusing position; and
determining a definition mapping curve based on the plurality of focusing positions and the plurality of definition scores, and moving the objective lens and/or the target surface to enable the focusing position to be at a fine focusing position, such that the imaging assembly acquires a clear image of the target surface, the definition score at the fine focusing position being determined based on a peak of the definition mapping curve.

Disclosed is a microscopy system. The microscopy system includes a memory and a processor. The memory stores a computer program, and the processor, when executing the computer program, implements the steps of the focusing method according to the present disclosure.

Disclosed is a computer-readable storage medium having a computer program stored thereon. The computer program, when executed by a processor, causes the processor to implement the steps of the focusing method according to the present disclosure.

Additional aspects and advantages of the present disclosure will in part be illustrated in the following description and become apparent from the following description, or may be learned by the implementation of the present disclosure.

### BRIEF DESCRIPTION OF THE DRAWINGS

The aforementioned and/or additional aspects and advantages of the present disclosure will become apparent and easily understood from the description of the embodiments with reference to the following drawings, in which:

FIG. 1 is a schematic structural diagram of modules of a microscopy system according to some embodiments of the present disclosure;

FIG. 2 is a schematic flowchart of a focusing method according to some embodiments of the present disclosure;

FIG. 3 is another schematic structural diagram of modules of the microscopy system according to some embodiments of the present disclosure;

FIG. 4 is a schematic diagram of a definition mapping curve according to some embodiments of the present disclosure;

FIG. 5 is a schematic diagram of a coarse focusing operation according to some embodiments of the present disclosure;

FIG. 6 is another schematic flowchart of the focusing method according to some embodiments of the present disclosure;

FIG. 7 is yet another schematic flowchart of the focusing method according to some embodiments of the present disclosure;

FIG. 8 is a schematic diagram of first-order linear fitting of the definition mapping curve according to some embodiments of the present disclosure;

FIG. 9 is a schematic diagram of second-order parabolic fitting of the definition mapping curve according to some embodiments of the present disclosure;

FIG. 10 is still another schematic flowchart of the focusing method according to some embodiments of the present disclosure;

FIG. 11 is still another schematic flowchart of the focusing method according to some embodiments of the present disclosure;

FIG. 12 is a schematic structural diagram of a sequencing chip according to some embodiments of the present disclosure;

FIG. 13 is still another schematic flowchart of the focusing method according to some embodiments of the present disclosure;

FIG. 14 is a schematic flowchart of the focusing method in a sequencing-by-synthesis process according to some embodiments of the present disclosure; and

FIG. 15 is yet another schematic structural diagram of modules of the microscopy system according to some embodiments of the present disclosure.

### DETAILED DESCRIPTION OF THE INVENTION

In the description of the present disclosure, some of the disclosed contents have been correspondingly shown in the accompanying drawings, throughout which identical or similar reference numerals represent identical or similar elements or elements having identical or similar functions. The contents described below with reference to the drawings are exemplary and are merely intended to illustrate the present disclosure, and should not be construed as limiting the present disclosure.

In the description of the present disclosure, many different contents or examples are disclosed for implementing different structures of the present disclosure. To simplify the disclosure of the present application, the components and settings of specific examples are described below. Certainly, the examples are merely exemplary and are not intended to limit the present disclosure.

In addition, the terms “first” and “second” are used herein for descriptive purposes only and should not be construed as indicating or implying relative importance or implicitly indicating the number of technical features described. Therefore, features defined with “first” and “second” may explicitly or implicitly include one or more of the features. In the description of the present disclosure, unless otherwise clearly and specifically defined, the term “plurality” means two or more.

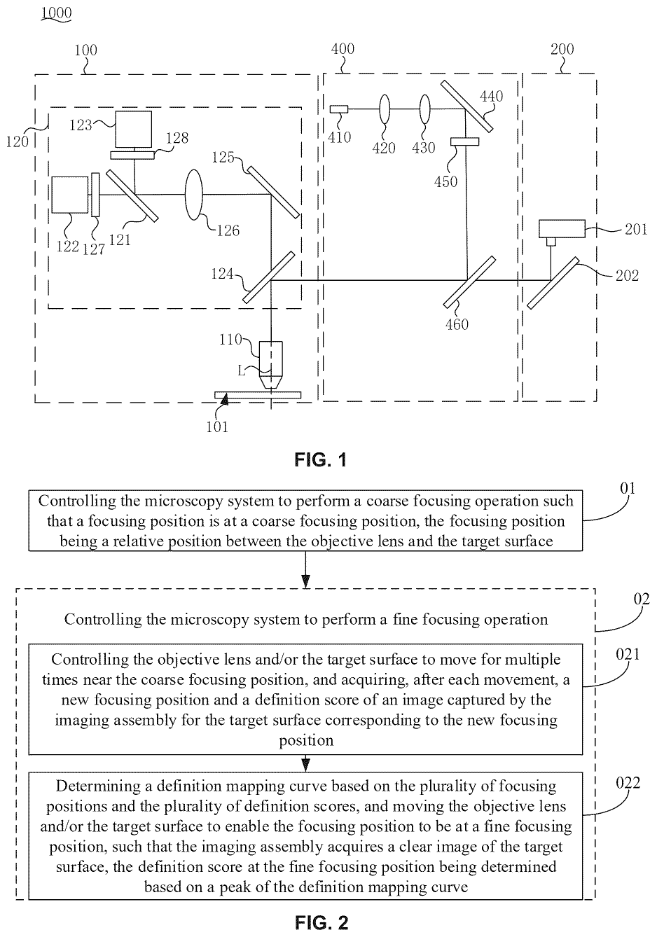

Specifically, referring to FIG. 1, in the present disclosure, the microscopy system 1000 may include an optical imaging system 100. The optical imaging system 100 may include an objective lens 110 and an imaging assembly 120. The imaging assembly 120 may include a first dichroic mirror 121, a first camera 122, a second camera 123, a second dichroic mirror 124, a first reflective mirror 125, and a tube lens 126. When the light ray is reflected from the target surface 101, the light ray may be first transmitted and reflected by the second dichroic mirror 124. The light ray transmitted through the second dichroic mirror 124 is first reflected by the first reflective mirror 125, and then irradiates the first dichroic mirror 121 through the tube lens 126. Similarly, light ray irradiated on the first dichroic mirror 121 is transmitted and reflected by the first dichroic mirror 121, such that light with a first wavelength in the light ray is transmitted through the first dichroic mirror 121 and enters the first camera 122 for imaging, and light with a second wavelength in the light ray is reflected by the first dichroic mirror 121 and enters the second camera 123 for imaging. In FIG. 1, the microscopy system 1000 may further include a first optical filter 127 and a second optical filter 128. The first optical filter 127 is disposed between the first dichroic mirror 121 and the first camera 122, such that the light ray transmitted through the first dichroic mirror 121 can be filtered. The second optical filter 128 is disposed between the first dichroic mirror 121 and the second camera 123, such that the light ray reflected by the first dichroic mirror 121 can be filtered.

Additionally, in FIG. 1, the microscopy system 1000 may include a laser illumination assembly 400. The laser illumination assembly 400 may include a laser 410, a collimating lens 420, a converging lens 430, a second reflective mirror 440, a first lens 450, and a third dichroic mirror 460. The laser 410 may emit a laser beam. The laser beam is collimated and expanded by using the collimating lens 420, then is converged by using the converging lens 430, and then may be reflected by the second reflective mirror 440 to irradiate the first lens 450. After exiting from the first lens 450, the laser beam is reflected by the third dichroic mirror 460 and the second dichroic mirror 124 in sequence, and finally irradiates the target surface 101 through the objective lens 110. In some cases, the first lens 450 may be an EX lens.

Referring to FIG. 1, the focusing method of the present disclosure may be applied to a microscopy system 1000. The microscopy system 1000 may include an objective lens 110 and an imaging assembly 120 for imaging a target surface 101. Referring to FIG. 2, the focusing method may include:
01: controlling the microscopy system 1000 to perform a coarse focusing operation such that a focusing position is at a coarse focusing position, the focusing position being a relative position between the objective lens 110 and the target surface 101; and
02: controlling the microscopy system 1000 to perform a fine focusing operation, including:
021: controlling the objective lens 110 and/or the target surface 101 to move for multiple times near the coarse focusing position, and acquiring, after each movement, a new focusing position and a definition score of an image captured by the imaging assembly 120 for the target surface 101 corresponding to the new focusing position; and
022: determining a definition mapping curve based on the plurality of focusing positions and the plurality of definition scores, and moving the objective lens 110 and/or the target surface 101 to enable the focusing position to be at a fine focusing position, such that the imaging assembly 120 acquires a clear image of the target surface 101, the definition score at the fine focusing position being determined based on a peak of the definition mapping curve.

It should be noted that, in some scenarios to which the present disclosure is applied, after the fine focusing operation is performed on the microscopy system 1000 such that the focusing position is at the fine focusing position, the fine focusing position may be shifted by a certain distance. It should be understood that in practical applications, there may be mechanical structural limitations in the hardware of the microscopy system 1000. In the process of performing the fine focusing operation, such limitations will affect the movement of the objective lens 110 and/or the target surface 101, causing a deviation between the focusing position and the actual fine focusing position. This deviation is a mechanical deviation, such as mechanical backlash.

Based on the above, in some cases, step 022 may include the following step:

In the case of moving the objective lens 110 and/or the target surface 101 such that the definition score at the focusing position corresponds to the peak of the definition mapping curve, the objective lens 110 and/or the target surface 101 is moved again by a distance which is related to the mechanical deviation of the microscopy system 1000.

Based on the above, in some cases, step 022 may include the following step:

The objective lens 110 and/or the target surface 101 is moved such that the focusing position is at the fine focusing position, the definition score corresponding to the fine focusing position being determined based on the peak of the definition mapping curve and the mechanical deviation of the microscopy system 1000.

The above case may also be understood as that after the fine focusing operation is performed such that the focusing position is at the conceptual fine focusing position, the focusing position is shifted by a certain distance according to the mechanical deviation of the microscopy system 1000, or the mechanical deviation is considered when the fine focusing operation is performed to move the objective lens 110 and/or the target surface 101, and the focusing position is moved in combination with the peak of the definition mapping curve and the mechanical deviation, such that the focusing position can reach the actual fine focusing position. Currently, in some cases, since the mechanical deviation has only a very small value, it may be considered that the influence caused by the mechanical deviation is negligible.

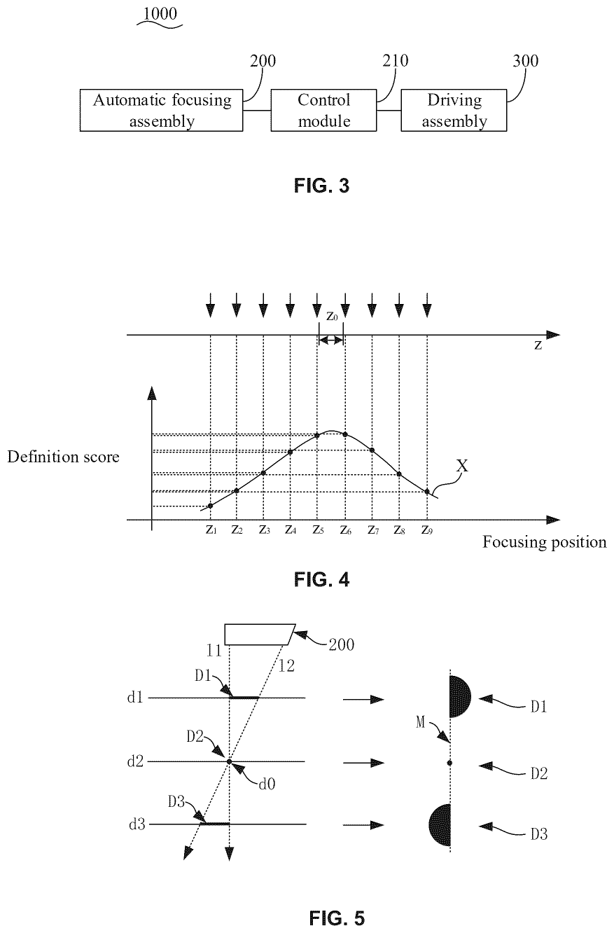

The focusing method of the present disclosure may be implemented by the microscopy system 1000 of the present disclosure. Specifically, referring to FIGS. 1 and 3, the microscopy system 1000 may further include a control module 210. The control module 210 may be configured for: controlling the microscopy system 1000 to perform a coarse focusing operation such that a focusing position is at a coarse focusing position, the focusing position being a relative position between the objective lens 110 and the target surface 101; and controlling the microscopy system 1000 to perform a fine focusing operation, including: controlling the objective lens 110 and/or the target surface 101 to move for multiple times near the coarse focusing position, and acquiring, after each movement, a new focusing position and a definition score of an image captured by the imaging assembly 120 for the target surface 101 corresponding to the new focusing position; and determining a definition mapping curve based on the plurality of focusing positions and the plurality of definition scores, and moving the objective lens 110 and/or the target surface 101 to enable the focusing position to be at a fine focusing position, such that the imaging assembly 120 acquires a clear image of the target surface 101, the definition score at the fine focusing position being determined based on a peak of the definition mapping curve.

In the focusing method and the microscopy system 1000 described above, by moving the objective lens 110 and/or the target surface 101, a new focusing position and a corresponding definition score are obtained, and then a plurality of focusing positions and a plurality of definition scores are obtained. The plurality of definition scores can be used to determine a definition mapping curve. The focusing position corresponding to the peak of the definition mapping curve can enable the imaging assembly 120 to acquire the clearest image, so that the focusing operation of the microscopy system 1000 can be controlled by the change condition of the definition score, thereby achieving an automatic focusing effect, making the focusing more accurate and faster, and improving the observation efficiency.

In the present disclosure, in some cases, the coarse focusing operation may be understood as adjusting at least one of the objective lens 110 and the target surface 101 such that the target surface 101 is quite close to the position of the focal plane of the objective lens 110, and at this time, the imaging assembly 120 can image the target surface 101 to obtain a relatively clear image. The fine focusing operation may be understood as further adjusting at least one of the objective lens 110 and the target surface 101 on the basis of the coarse focusing operation such that the target surface 101 is substantially located at the position of the focal plane of the objective lens 110, and at this time, the imaging assembly 120 can image the target surface 101 to obtain a quite clear image.

The objective lens 110 may have an optical axis. Referring to FIG. 1, in FIG. 1, the optical axis of the objective lens 110 is denoted as L. When the objective lens 110 and the target surface 101 are at a certain or determinable relative position, a distance of a corresponding magnitude is also formed between the objective lens 110 and the target surface 101 along the direction of the optical axis. In this case, although the objective lens 110 or the target surface 101 can move to any position on the optical axis, the relative position remains unchanged, such that the distance formed between the objective lens 110 and the target surface 101 along the direction of the optical axis remains unchanged or substantially unchanged, and then the image obtained by imaging the target surface 101 by the objective lens 110 also has a certain or substantially unchanged definition.

In the present disclosure, in some cases, when the relative position between the objective lens 110 and the target surface 101 is at the coarse focusing position, the distance formed between the objective lens 110 and the target surface 101 along the direction of the optical axis of the objective lens 110 is smaller than a first distance; when the relative position between the objective lens 110 and the target surface 101 is at the fine focusing position, the distance formed between the objective lens 110 and the target surface 101 along the direction of the optical axis of the objective lens 110 is smaller than a second distance, and the second distance is smaller than the first distance.

Referring to FIGS. 1 and 4, in FIG. 4, the z-axis may be a coordinate axis parallel to the optical axis L. In some cases, when the microscopy system 1000 is controlled to perform the coarse focusing operation, at least one of the objective lens 110 and the target surface 101 may be moved along the optical axis L, such that the target surface 101 is located within the Z₀ interval on the optical axis L, that is, the focusing position is at the coarse focusing position at this time. Then, when the microscopy system 1000 is controlled to perform the fine focusing operation, at least one of the objective lens 110 and the target surface 101 may be controlled to move, such that the target surface 101 moves for multiple times along the optical axis L relative to the objective lens 110 with a position within the Z₀ interval as a starting position. In FIG. 4, the positions at which the target surface 101 can stay after moving for multiple times may be represented as Z₁, Z₂, Z₃, Z₄, Z₅, Z₆, Z₇, Z₈, and Z₉, respectively. In other words, Z₁, Z₂, Z₃, Z₄, Z₅, Z₆, Z₇, Z₈, and Z₉ can all be used as new focusing positions. It should be understood that different images can be captured at these new focusing positions, and since the distance between the objective lens 110 and the target surface 101 has changed, these captured different images may also have corresponding different definition scores. The plurality of acquired focusing positions and definition scores can be processed to determine the definition mapping curve. In FIG. 4, the definition mapping curve is represented as X.

Since the smaller the distance between the target surface 101 and the focal plane of the objective lens 110 is, the clearer the captured image will be. It can be easily known from FIG. 4 that after the definition mapping curve is determined, it can be determined that the peak of the definition mapping curve is the position of the focal plane of the objective lens 110, so that the position corresponding to the peak of the definition mapping curve on the optical axis L can be used as the fine focusing position, and at least one of the objective lens 110 or the target surface 101 is controlled to move, such that the target surface 101 can finally be at the fine focusing position, thereby completing the focusing on the target surface 101 through the fine focusing operation.

In the present disclosure, the step 01 (controlling the microscopy system 1000 to perform the coarse focusing operation such that the focusing position is at the coarse focusing position) may include:
outputting a first focusing light ray to the objective lens 110 along an optical axis of the objective lens 110, where the first focusing light ray can be focused into a point on a focal plane of the objective lens 110; in a process in which the target surface 101 moves along the optical axis from a position between the objective lens 110 and the focal plane to the focal plane, the first focusing light ray forms an image in a first area on the target surface 101, and an imaging size gradually decreases; and in a process in which the target surface 101 moves along the optical axis from the focal plane to a position away from the objective lens 110, the first focusing light ray forms an image in a second area on the target surface 101, and the imaging size gradually increases, the first area and the second area being axisymmetric on the target surface 101; and
determining, based on an imaging change of the first focusing light ray on the target surface 101 during the movement of the target surface 101, a position of the target surface 101 at which the first focusing light ray is imaged into a point as a position of the focal plane, and moving the objective lens 110 and/or the target surface 101 such that the target surface 101 is at the position of the focal plane.

The focusing method of the present disclosure may be implemented by the microscopy system 1000 of the present disclosure. Specifically, referring to FIG. 3, the control module 210 may be configured for: outputting a first focusing light ray to the objective lens 110 along an optical axis of the objective lens 110, where the first focusing light ray can be focused into a point on a focal plane of the objective lens 110; in a process in which the target surface 101 moves along the optical axis from a position between the objective lens 110 and the focal plane to the focal plane, the first focusing light ray forms an image in a first area on the target surface 101, and an imaging size gradually decreases; and in a process in which the target surface 101 moves along the optical axis from the focal plane to a position away from the objective lens 110, the first focusing light ray forms an image in a second area on the target surface 101, and the imaging size gradually increases, the first area and the second area being axisymmetric on the target surface 101; and determining, based on an imaging change of the first focusing light ray on the target surface 101 during the movement of the target surface 101, a position of the target surface 101 at which the first focusing light ray is imaged into a point as a position of the focal plane, and moving the objective lens 110 and/or the target surface 101 such that the target surface 101 is at the position of the focal plane.

As such, the coarse focusing efficiency of the microscopy system 1000 can be improved.

Specifically, referring to FIG. 1, the microscopy system 1000 may include an automatic focusing assembly 200. The automatic focusing assembly 200 may include a first light source (not shown) and a focusing sensor 201. The first light source is configured to provide a first focusing light ray, e.g., infrared light of 850 nm. The objective lens 110 is configured to project the first focusing light ray onto the target surface 101 and collect the first focusing light ray reflected from the target surface 101. The focusing sensor 201 may receive the first focusing light ray collected by the objective lens 110 and reflected from the target surface 101, to obtain first focusing light ray information. In some cases, the focusing sensor 201 may include a charge-coupled device (CCD) array, and the focusing sensor 201 may detect the shape and size of a spot formed by the first focusing light ray through the CCD array. According to the shape and size of the spot, it can be determined whether the target surface 101 is located on the focal plane of the objective lens 110, thereby achieving the coarse focusing operation.

The focusing sensor 201 and the first light source may be located at different positions. In some cases, the focusing sensor 201 and the first light source may be located at different positions on a same horizontal plane. In this case, the target surface 101, the focusing sensor 201, and the first light source may form a triangle. According to a triangular ranging principle, when a relative distance (usually a distance in the vertical direction) between the target surface 101 and the focusing sensor 201 remains unchanged, the first focusing light ray reflected from the target surface 101 forms an image at a fixed position on the CCD array. When the relative distance between the target surface 101 and the focusing sensor 201 changes, an imaging position on the CCD array also changes. Therefore, the relative distance between the target surface 101 and the focusing sensor 201 may be determined based on the change of the imaging position on the CCD array.

In some cases, the CCD array may perform photoelectric conversion on the received first focusing light ray and then output a corresponding voltage. As such, a reference voltage of a reference position on the CCD array may be set, such that the voltage output by the photoelectric conversion of the CCD array corresponds to the relative distance between the target surface 101 and the focusing sensor 201. That is, when the relative distance between the target surface 101 and the focusing sensor 201 is constant, the voltage output by the photoelectric conversion of the CCD array is also constant. The first light source may be a built-in light source of the focusing sensor 201. The automatic focusing assembly 200 may further include a third reflector 202. The third reflector 202 may be configured to reflect the first focusing light ray, such that a propagation optical path of the first focusing light ray may be changed, and then the focusing sensor 201 can be adapted to specific requirements to adjust the installation position in the automatic focusing assembly 200.

The first light source may emit the first focusing light rays in a plurality of different directions, and all of the emitted first focusing light rays are allowed to be focused into a point on the focal plane. Based on the above, referring to FIG. 5, the first focusing light ray may include a light ray l1 and a light ray l2. Both the light ray l1 and the light ray l2 pass through the focus d0. All the first focusing light rays may be emitted toward the focus d0, such that all the first focusing light rays can gradually converge when approaching the focus d0, then converge at the focus d0, and then gradually diffuse when moving away from the focus d0. For the first light source, the light ray l1 may be emitted from one end of the first light source in a direction perpendicular to the focal plane, and the light ray l2 may be emitted from the other end of the first light source at a corresponding oblique angle. The first focusing light rays may be a semicircular light beam when exiting from the first light source.

In FIG. 5, when the plane on which the focal plane is located coincides with a plane d2, the focus d0 is also located on the plane d2. In this case, an image obtained by imaging the plane d2 is a light spot, namely, D2 shown in FIG. 5. When the plane d1 located between the automatic focusing assembly 200 and the plane d2 is imaged, because a light beam formed by the first focusing light rays between the plane d1 and the plane d2 is gradually converged, an image of the first focusing light ray formed on the plane d1 may be D1 shown in FIG. 5. When the plane d3 located on the other side of the plane d2 is imaged, because a light beam formed by the first focusing light rays between the plane d2 and the plane d3 is gradually diffused, an image of the first focusing light ray formed on the plane d3 may be D3 shown in FIG. 5.

When the first focusing light rays become a semicircular light beam when exiting from the first light source, in FIG. 5, both D1 and D3 are semicircular, a straight edge of the semicircular shape of D1 and a straight edge of the semicircular shape of D3 may be located on a straight line M, and D2 may also be located on the straight line M. It should be understood that, based on the foregoing characteristics of the first focusing light rays emitted by the first light source, the image of the first focusing light rays on the plane d1 and the image of the first focusing light rays on the plane d3 are respectively located on both sides of the straight line M, and the image of the first focusing light rays on the plane d2 converges into a point. That is, based on the graphic shape of the images of the first focusing light rays, a positional relationship between the focal plane on which the current image is formed and the plane on which the focus d0 is located may be determined, and a direction in which and a distance by which the focal plane needs to be moved may be further determined, so that when a coarse focusing operation is performed, the coarse focusing efficiency can be improved.

In addition, in some cases, the positional relationship between the focal plane and the plane on which the focus d0 is located may be determined based on the range and intensity of light sensing.

In the present disclosure, the step 01 (controlling the microscopy system 1000 to perform the coarse focusing operation such that the focusing position is at the coarse focusing position) may include:
controlling the microscopy system 1000 to image the target surface 101, and moving the objective lens 110 and/or the target surface 101 by a first set step length when no image of the target surface 101 is acquired, and then imaging the target surface 101 until an image of the target surface 101 is successfully acquired.

The focusing method of the present disclosure may be implemented by the microscopy system 1000 of the present disclosure. Specifically, referring to FIG. 3, the control module 210 may be configured for: controlling the microscopy system 1000 to image the target surface 101, and moving the objective lens 110 and/or the target surface 101 by a first set step length when no image of the target surface 101 is acquired, and then imaging the target surface 101 until an image of the target surface 101 is successfully acquired.

In this way, a full-image focusing effect of the microscopy system 1000 can be achieved.

Specifically, the whole target surface 101 may be imaged, and as the imaging is sequentially performed at the first set step length, the target surface 101 may form a relatively clear rough contour in one or several images, so that it may be determined that the position where the target surface 101 is located is close to the focal plane of the objective lens 110, that is, the focusing position is at the coarse focusing position.

In addition, in some cases, when coarse focusing is not achieved by optical focusing, coarse focusing may be performed by full-image focusing. If coarse focusing cannot be completed for both optical focusing and full-image focusing, it indicates that the current focusing fails.

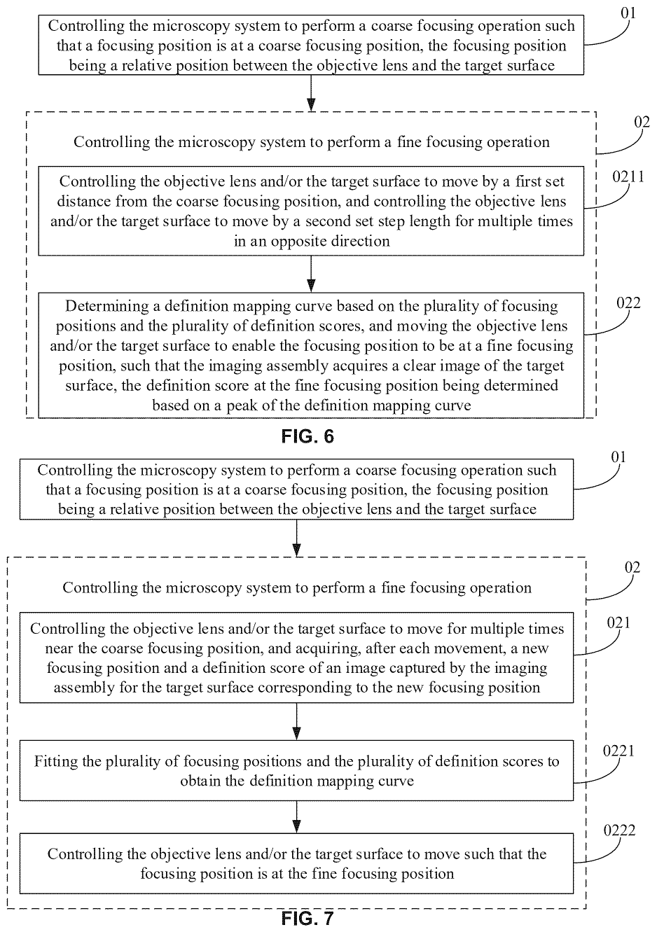

Referring to FIG. 6, in the present disclosure, the step 021 (controlling the objective lens 110 and/or the target surface 101 to move for multiple times near the coarse focusing position, and acquiring, after each movement, a new focusing position and a definition score of an image captured by the imaging assembly 120 for the target surface 101 corresponding to the new focusing position) may include:
0211: controlling the objective lens 110 and/or the target surface 101 to move by a first set distance from the coarse focusing position, and controlling the objective lens 110 and/or the target surface 101 to move by a second set step length for multiple times in an opposite direction.

The focusing method of the present disclosure may be implemented by the microscopy system 1000 of the present disclosure. Specifically, referring to FIG. 3, the control module 210 may be configured for: controlling the objective lens 110 and/or the target surface 101 to move by a first set distance from the coarse focusing position, and controlling the objective lens 110 and/or the target surface 101 to move by a second set step length for multiple times in an opposite direction.

In some cases, the step 0211 may be to control the objective lens 110 and/or the target surface 101 to move by a first set distance along the positive direction of the Z-axis, and then move by a second set step length for multiple times along the negative direction of the Z-axis. In some other cases, the step 0211 may be to control the objective lens 110 and/or the target surface 101 to move by a first set distance along the negative direction of the Z-axis, and then move by a second set step length for multiple times along the positive direction of the Z-axis. A specific moving manner may be selected based on an actual application scenario.

In this way, a focusing effect can be ensured.

Specifically, referring to FIG. 4, the target surface 101 is substantially within the range of Z₀ on the optical axis L. When a fine focusing operation is performed, the target surface 101 may move from the position thereof to Z₁ along the negative direction of the optical axis L, such that the target surface 101 moves by the first set distance relative to the optical axis L, and then moves by the second set step length along the positive direction of the optical axis L, such that the target surface 101 sequentially stays at Z₁, Z₂, Z₃, Z₄, Z₅, Z₆, Z₇, Z₈, and Z₉. That is, the distances between adjacent Z₁, Z₂, Z₃, Z₄, Z₅, Z₆, Z₇, Z₈, and Z₉ are the second set step length.

It should be understood that by performing the step 0211, the change in the image definition within a large range around Z₀ can be acquired, such that the definition mapping curve can characterize the correspondence between the imaging definition of the target surface 101 and the position of the target surface 101 along the optical axis, and then the position of the peak of the definition mapping curve on the optical axis is as close as possible to the focal plane of the objective lens 110. After the fine focusing operation is performed such that the focusing position is at the fine focusing position, the imaging of the target surface 101 is as clear as possible, thereby ensuring the focusing effect.

In the present disclosure, the second set step length may be greater than the depth of field of the objective lens 110. In some cases, the depth of field may be 0.2 mm, and the value of the second set step length may range from 0.3 mm to 0.5 mm, such as 0.3 mm, 0.31 mm, 0.32 mm, 0.33 mm, 0.34 mm, 0.35 mm, 0.36 mm, 0.37 mm, 0.38 mm, 0.39 mm, 0.4 mm, 0.41 mm, 0.42 mm, 0.43 mm, 0.44 mm, 0.45 mm, 0.46 mm, 0.47 mm, 0.48 mm, 0.49 mm, 0.5 mm.

In this way, the focusing accuracy can be improved.

Specifically, after the forward and backward movements are performed at the second set step length, the imaging definition obtained through the objective lens 110 may have a relatively obvious change and is easy to distinguish, such that the definition mapping curve can better fit the actual correspondence between the definition score and the position of the target surface 101 along the optical axis, and then the focusing accuracy can be improved when the fine focusing operation is performed through the definition mapping curve.

In addition, it should be noted that the second set step length should be slightly greater than the depth of field of the objective lens 110. If the second set step length is too large relative to the depth of field of the objective lens 110, the number of obtained definition scores may be too small, which may easily cause the taken point to be far away from the position of the focal plane and cause the relevant information near the focal plane to be lost. In this way, the basic trend of the actual definition mapping curve cannot be accurately reflected, and thus the focusing accuracy can be greatly affected.

Referring to FIG. 1, in the present disclosure, the microscopy system 1000 may include an automatic focusing assembly 200. The focusing method may include:
controlling the automatic focusing assembly 200 to send a second focusing light ray to the target surface 101 along an optical axis of the objective lens 110, receiving the second focusing light ray reflected by the target surface 101, and outputting an electrical signal according to the received second focusing light ray, the electrical signal being related to the focusing position; and
the step 021 (controlling the objective lens 110 and/or the target surface 101 to move for multiple times near the coarse focusing position, and acquiring, after each movement, a new focusing position and a definition score of an image captured by the imaging assembly 120 for the target surface 101 corresponding to the new focusing position) may include:
controlling the objective lens 110 and/or the target surface 101 to move according to the electrical signal.

The focusing method of the present disclosure may be implemented by the microscopy system 1000 of the present disclosure. Specifically, referring to FIG. 3, the control module 210 may be configured for: controlling the automatic focusing assembly 200 to send a second focusing light ray to the target surface 101 along an optical axis of the objective lens 110, receiving the second focusing light ray reflected by the target surface 101, and outputting an electrical signal according to the received second focusing light ray, the electrical signal being related to the focusing position; and controlling the objective lens 110 and/or the target surface 101 to move according to the electrical signal.

In this way, a problem that the focusing accuracy is reduced due to an optical axis shift during focusing based on the optical axis can be avoided.

Specifically, in general, if focusing is performed according to the optical axis (in particular, the optical axis moves in a positive direction and then moves in a negative direction, such that the target surface 101 reaches the focal plane), the focusing may be inaccurate.

In FIG. 1, the automatic focusing assembly 200 emits a second focusing ray. Because there is a correspondence between the position of the target surface 101 along the optical axis and the definition score of imaging the target surface 101, if the position of the target surface 101 along the optical axis changes, the second focusing light ray received by the automatic focusing assembly 200 also changes (e.g., duration from sending the second focusing light ray to receiving the second focusing light ray is different). Based on this change, the automatic focusing assembly 200 may output a corresponding electrical signal based on the received second focusing light ray, further establish a correspondence between the electrical signal and the focusing position, and then determine the focusing position or the position of the target surface 101 along the optical axis based on the correspondence and the electrical signal. Compared with a manner of directly adjusting and determining the focusing position by using the optical axis, a case where the focusing accuracy is reduced due to an optical axis shift can be avoided. The electrical signal may include voltage, current, and power. When the current focusing position changes, the electrical signal output by the automatic focusing assembly 200 also changes correspondingly in value; that is, the electrical signal is related to the focusing position.

It should be noted that the electrical signal feeds back the relative height formed between the objective lens 110 and the target surface 101 along the optical axis, and the position of the objective lens 110 on the optical axis is the absolute height formed by the objective lens 110 along the optical axis.

Based on the above, in some cases, during the fine focusing operation, the microscopy system 1000 may have fluctuations. For example, the target surface 101 has an up-and-down motion, resulting in low scanning accuracy when imaging at the peak position of the definition mapping curve, resulting in the need for multiple supplementary photographs, or the inability to photograph in sequence for some reason (corresponding to the step 0211 in the present disclosure).

For the above situation, since the value of the electrical signal is still accurate when the up-and-down activity occurs on the target surface 101, compared with the method of capturing images in the order of moving for multiple times by the second set step length, the present disclosure can also capture multiple images at random at positions close to the focal plane of the objective lens 110 through the automatic focusing assembly 200, and then use the correlation between the electrical signal and the focusing position to sort the captured images based on the magnitudes of the electrical signals, so as to acquire an effect similar to capturing images in the order of moving for multiple times by the second set step length. In this way, a photographing sequence may not affect the accuracy of the determined definition mapping curve.

Referring to FIG. 7, in the present disclosure, the step 022 (determining a definition mapping curve according to the plurality of focusing positions and the plurality of definition scores, and moving the objective lens 110 and/or the target surface 101 to enable the focusing position to be at a fine focusing position) may include:
0221: fitting the plurality of focusing positions and the plurality of definition scores to obtain the definition mapping curve; and
0222: controlling the objective lens 110 and/or the target surface 101 to move such that the focusing position is at the fine focusing position.

The focusing method of the present disclosure may be implemented by the microscopy system 1000 of the present disclosure. Specifically, referring to FIG. 3, the control module 210 may be configured for: fitting the plurality of focusing positions and the plurality of definition scores to obtain the definition mapping curve; and controlling the objective lens 110 and/or the target surface 101 to move such that the focusing position is at the fine focusing position.

In this way, a focusing effect of the fine focusing operation is facilitated.

Specifically, referring to FIG. 4, after each focusing position and the corresponding definition score are determined, a coordinate system may be established based on the focusing position and the definition score. A corresponding coordinate point may be determined for each focusing position and the corresponding definition score in the coordinate system, such that a plurality of coordinate points may be obtained. According to these coordinate points, fitting can be performed to obtain a definition mapping curve, which can reflect the change condition of the definition score with the change of the focusing position. The position of the focal plane of the objective lens 110 can be determined based on the peak of the definition mapping curve, and the objective lens 110 and/or the target surface 101 is controlled to move such that the target surface 101 is located at the position of the corresponding peak on the optical axis, that is, the target surface 101 can be located at the position of the focal plane of the objective lens 110, thereby achieving a focusing effect of the fine focusing operation.

In the present disclosure, the step 0221 (fitting the plurality of focusing positions and the plurality of definition scores to obtain the definition mapping curve) may include:
determining to control the microscopy system 1000 to re-perform the coarse focusing operation and/or the fine focusing operation when the definition mapping curve meets a set condition.

The focusing method of the present disclosure may be implemented by the microscopy system 1000 of the present disclosure. Specifically, referring to FIG. 3, the control module 210 may be configured for determining to control the microscopy system 1000 to re-perform the coarse focusing operation and/or the fine focusing operation when the definition mapping curve meets a set condition.

In this way, impact on a final focusing effect due to some factors can be avoided.

It should be understood that during the actual focusing process, the influence of some related factors may be encountered, such that the obtained definition mapping curve is different from the expected situation (e.g., the peak of the definition mapping curve cannot be found), that is, the definition mapping curve meets the set condition. In this case, at least one of the coarse focusing operation and the fine focusing operation may be re-performed to exclude the influence of related factors as much as possible, so as to ensure that the definition mapping curve that matches the actual situation is obtained as much as possible.

In the present disclosure, the set condition may include at least one of the following:
when the number of the plurality of definition scores is greater than a set number, the peak of the definition mapping curve still cannot be fitted;
when the objective lens 110 and/or the target surface 101 moves to a maximum scanning distance, the peak of the definition mapping curve still cannot be fitted;
the plurality of definition scores obtained in sequence have a gradually decreasing trend; a fluctuation amplitude of the definition mapping curve is less than a set amplitude value, and a maximum value of the definition score is less than a set score; and
the definition mapping curve has a plurality of peaks.

In this way, the influence of the failure of the previous coarse focusing operation on the fitting process can be reduced.

Specifically, in some cases, if the number of the plurality of definition scores obtained is greater than the set number, but the peak of the definition mapping curve still cannot be fitted, it can be determined that the focal plane of the objective lens 110 exceeds the adjustment range that the focusing position can currently reach, such that the focusing position cannot reach the fine focusing position, and then the definition score needs to be reacquired.

In some cases, if the peak of the definition mapping curve still cannot be fitted when the objective lens 110 and/or the target surface 101 moves to the maximum scanning distance, it can be determined that the focal plane of the objective lens 110 exceeds the distance range that the objective lens 110 and/or the target surface 101 can currently reach, such that the focusing position cannot reach the fine focusing position, and then the definition score needs to be reacquired.

In some cases, if the plurality of definition scores sequentially obtained have a gradually decreasing trend, it may indicate that the plurality of obtained definition scores are all acquired through unidirectional sampling on the focal plane of the objective lens 110 along the optical axis, and the position of the focal plane of the objective lens 110 along the optical axis is not within the sampling point interval formed by the plurality of obtained definition scores, or the second set step length is too large compared to the depth of field of the objective lens 110. Only one or two definition scores are acquired on the focal plane of the objective lens 110 in one direction along the optical axis, and other definition scores are acquired on the focal plane of the objective lens 110 in other directions along the optical axis, such that the change trend of the plurality of obtained definition scores does not accurately reflect the basic trend of the actual definition mapping curve, and then the definition scores need to be reacquired.

In some cases, if the fluctuation amplitude of the definition mapping curve is less than the set amplitude value, and the maximum value of the definition score is less than the set score, it may indicate that the points on the definition mapping curve corresponding to the currently acquired definition scores are all far away from the position of the focal plane of the objective lens 110 along the optical axis, and are basically at both ends of the definition mapping curve. This is because the actual definition mapping curve has a relatively large change trend at the peak (corresponding to the position of the focal plane of the objective lens 110 along the optical axis), and the definition scores corresponding to the points around the peak are relatively high. Therefore, it can be determined that the current sampling point does not take a point close to the peak, and the definition mapping curve obtained based on these definition scores cannot reflect the change trend of the actual definition mapping curve at the peak, so that the definition scores need to be reacquired.

In some cases, if the definition mapping curve has a plurality of peaks, it may indicate that a part of the definition scores are acquired with deviations, such that the part of the definition scores are relatively too large or too small. In this case, the obtained definition mapping curve cannot reflect a change trend of the actual definition mapping curve at the peaks, and then the definition scores need to be reacquired.

It should be understood that, on the basis of satisfying at least one of the above set conditions, it can be determined that the specific position of the focal plane of the objective lens 110 cannot be determined based on the peak on the currently obtained definition mapping curve; that is, the previous coarse focusing operation does not achieve the expected coarse focusing effect, or the coarse focusing fails, so the current fine focusing operation needs to be interrupted, and the focusing needs to be restarted from the coarse focusing operation, or the fine focusing operation needs to be re-performed, thereby reducing the influence caused by the large distance between the current target surface 101 and the focal plane of the objective lens 110 and ensuring the fitting accuracy of the subsequent definition mapping curve.

In the present disclosure, the step 0221 (fitting the plurality of focusing positions and the plurality of definition scores to obtain the definition mapping curve) may include: performing first-order linear fitting on a part of the plurality of definition scores showing an upward trend to obtain a first fitting straight line, performing first-order linear fitting on a part of the plurality of definition scores showing a downward trend to obtain a second fitting straight line, and determining an intersection point of the first fitting straight line and the second fitting straight line as the peak of the definition mapping curve.

The focusing method of the present disclosure may be implemented by the microscopy system 1000 of the present disclosure. Specifically, referring to FIG. 3, the control module 210 may be configured for: performing first-order linear fitting on a part of the plurality of definition scores showing an upward trend to obtain a first fitting straight line, performing first-order linear fitting on a part of the plurality of definition scores showing a downward trend to obtain a second fitting straight line, and determining an intersection point of the first fitting straight line and the second fitting straight line as the peak of the definition mapping curve.

In this way, a fitting effect can be simply achieved.

In this embodiment, the first fitting straight line and the second fitting straight line are obtained in a first-order linear fitting manner. The first-order linear fitting is also often referred to as linear regression fitting, and its purpose is to find a straight line such that a given set of data points is as close as possible to the straight line to some extent. The equation of this straight line is usually expressed in the form of y=ax+b, where a represents the slope of the straight line, which determines the degree of inclination of the straight line, and b represents the intercept of the straight line on the y-axis. Common fitting methods include a least square method, a gradient descent method, and the like.

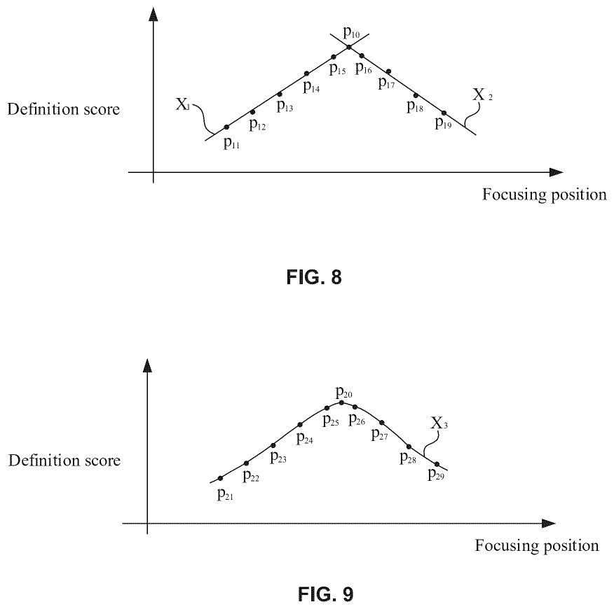

Specifically, referring to FIG. 8, in FIG. 8, after the objective lens 110 and/or the target surface 101 is controlled to move for multiple times near the coarse focusing position, a plurality of points located in the coordinate system, i.e., p₁₁, p₁₂, p₁₃, p₁₄, p₁₅, p₁₆, p₁₇, p₁₈, and p₁₉ in FIG. 8, can be determined based on the respective focusing positions and the corresponding definition scores. With the positive change of the focusing position, p₁₁, p₁₂, p₁₃, p₁₄, and p₁₅ have a trend of sequentially increasing definition scores, and p₁₆, p₁₇, p₁₈, and p₁₉ have a trend of sequentially decreasing definition scores, such that first-order linear fitting can be performed on p₁₁, p₁₂, p₁₃, p₁₄, and p₁₅ to obtain a first fitting straight line X₁, and first-order linear fitting can be performed on p₁₆, p₁₇, p₁₈, and p₁₉ to obtain a second fitting straight line X₂. Then, an intersection point p₁₀ between the first fitting straight line X₁ and the second fitting straight line X₂ may be determined as a peak of the definition mapping curve.

It should be understood that, through the above first-order linear fitting processing, on the basis of ensuring a certain fitting precision, the flow of the fitting processing can be simplified to improve the efficiency of the fitting processing.

The step 0221 (fitting the plurality of focusing positions and the plurality of definition scores to obtain the definition mapping curve) may include:
performing second-order parabolic fitting on the plurality of definition scores to obtain a first fitting parabolic curve, and determining a vertex of the first fitting parabolic curve as the peak of the definition mapping curve.

The focusing method of the present disclosure may be implemented by the microscopy system 1000 of the present disclosure. Specifically, referring to FIG. 3, the control module 210 may be configured for performing second-order parabolic fitting on the plurality of definition scores to obtain a first fitting parabolic curve, and determining a vertex of the first fitting parabolic curve as the peak of the definition mapping curve.

In this way, it is beneficial to improve the fitting accuracy of the actual situation.

In this embodiment, a second-order parabolic fitting manner is used to obtain a first fitting parabolic curve. The second-order parabolic fitting manner is to find a parabolic equation to approximate a given set of data points, and a general equation form of the parabolic curve is y=ax²+bx+c, where a, b, and c represent parameters that need to be determined. a≠0, which determines the opening direction (a>0, the opening is upward, and a<0, the opening is downward) and the bending degree of the parabolic curve, b affects the position of the symmetry axis of the parabolic curve, etc., and c represents the vertical coordinate of the intersection point of the parabolic curve and the y-axis. Common fitting methods include a least square method and the like.

Specifically, referring to FIG. 9, in FIG. 9, after the objective lens 110 and/or the target surface 101 is controlled to move for multiple times near the coarse focusing position, a plurality of points located in the coordinate system, i.e., p₂₁, p₂₂, p₂₃, p₂₄, p₂₅, p₂₆, p₂₇, p₂₈, and p₂₉ in FIG. 9, can be determined based on the respective focusing positions and the corresponding definition scores. Second-order parabolic fitting is performed on p₂₁, p₂₂, p₂₃, p₂₄, p₂₅, p₂₆, p₂₇, p₂₈, and p₂₉ to obtain a first fitting parabolic curve X₃. Then, the peak of the definition mapping curve can be determined based on the vertex p₂₀ of the first fitting parabolic curve X₃.

It should be understood that the above second-order parabolic processing can fit a change trend of image definition in an actual case, thereby improving the fitting accuracy of the actual case.

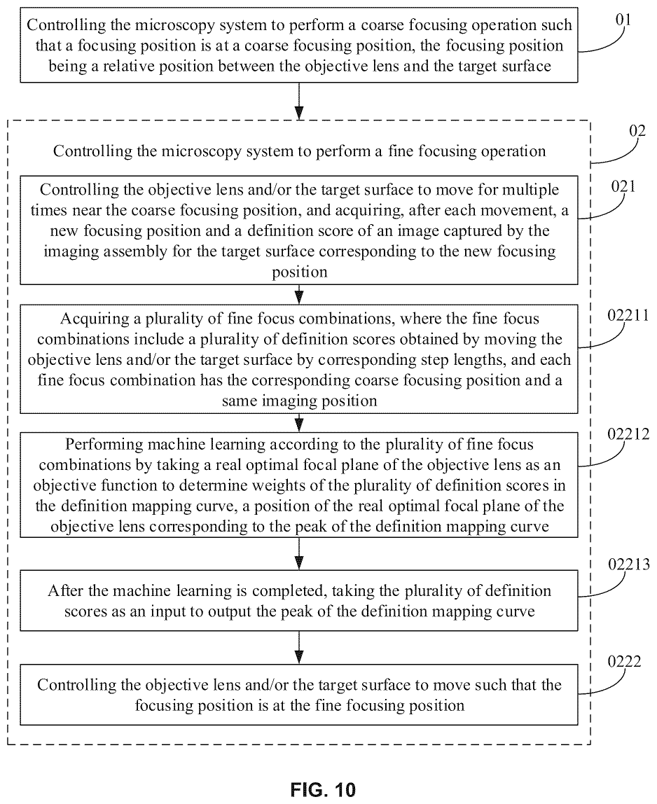

Referring to FIG. 10, the step 0221 (fitting the plurality of focusing positions and the plurality of definition scores to obtain the definition mapping curve) may include:
02211: acquiring a plurality of fine focus combinations, where the fine focus combinations include a plurality of definition scores obtained by moving the objective lens 110 and/or the target surface 101 by corresponding step lengths, and each fine focus combination has the corresponding coarse focusing position and a same imaging position;
02212: performing machine learning according to the plurality of fine focus combinations by taking a real optimal focal plane of the objective lens 110 as an objective function to determine weights of the plurality of definition scores in the definition mapping curve, a position of the real optimal focal plane of the objective lens 110 corresponding to the peak of the definition mapping curve; and
02213: after the machine learning is completed, taking the plurality of definition scores as an input to output the peak of the definition mapping curve.

The focusing method of the present disclosure may be implemented by the microscopy system 1000 of the present disclosure. Specifically, referring to FIG. 3, the control module 210 may be configured for: acquiring a plurality of fine focus combinations, where the fine focus combinations include a plurality of definition scores obtained by moving the objective lens 110 and/or the target surface 101 by corresponding step lengths, and each fine focus combination has the corresponding coarse focusing position and a same imaging position; performing machine learning according to the plurality of fine focus combinations by taking a real optimal focal plane of the objective lens 110 as an objective function to determine weights of the plurality of definition scores in the definition mapping curve, a position of the real optimal focal plane of the objective lens 110 corresponding to the peak of the definition mapping curve; and after the machine learning is completed, taking the plurality of definition scores as an input to output the peak of the definition mapping curve.

In this way, the fitting result can fit the actual situation as much as possible.

In an actual application scenario, although the definition mapping curve obtained by fitting is different in specific situations, the overall change trend can be determined. That is, the closer to the position of the focal plane of the objective lens 110, the greater the corresponding definition score, and the definition score corresponding to the position of the focal plane of the objective lens 110 is the maximum value; namely, the part of the actual definition mapping curve close to the peak can more clearly reflect the change trend at the peak.

Specifically, in some cases, because the definition score obtained by imaging at the position that is on the optical axis and that is close to the focal plane is also close to the definition score of the target surface 101 at the position of the focal plane, or a fluctuation amplitude of the definition score within a range of the position that is on the optical axis and that is close to the position of the focal plane is small, and the definition score at the position that is on the optical axis and that is away from the focal plane has a relatively large fluctuation, when a definition score at the position that is away from the focal plane is introduced for fitting processing, the fluctuation at the position that is away from the focal plane is also introduced, thereby affecting the position of the peak of the definition mapping curve.

Based on the above, in the present disclosure, the definition scores in the plurality of fine focus combinations may be used as an input of an initial learning model, the actual focal plane of the objective lens 110 is used as an objective function, then the output of the initial learning model is compared with the objective function, the parameters of the learning model may be adjusted according to the comparison result, then the definition scores in the plurality of fine focus combinations are input, and then the output is compared with the objective function until the error formed by the obtained comparison result meets the expectation, so that the current learning model may be used as a machine model for outputting the definition mapping curve. In some cases, adjusting the parameters of the learning model may be adjusting the weight of each definition score in the learning model.

It should be understood that, by performing machine learning, a degree of impact of fluctuation of each fine focus combination on a peak during fitting processing may be determined, and thus weight allocation may be performed on the fine focus combinations. In this way, a relatively small weight is allocated to a fine focus combination that has relatively large fluctuation impact on the peak, and a relatively large weight is allocated to a fine focus combination that has relatively small fluctuation impact on the peak, thereby reducing, as much as possible, fluctuation impact on the peak in the fine focus combination introduced into fitting processing, such that a fitting result fits an actual situation as much as possible.

In addition, in some cases, for fine focus combinations with large fluctuation impact, the weight may be adjusted to 0, that is, these fine focus combinations are removed, so as to further improve the degree of fitting to actual situations.

In the present disclosure, the focusing method may include:
using a sharpness value of an image obtained through imaging as the definition score.

The focusing method of the present disclosure may be implemented by the microscopy system 1000 of the present disclosure. Specifically, referring to FIG. 3, the control module 210 may be configured for using a sharpness value of an image obtained through imaging as the definition score.

### In This Way, it Is Beneficial to Improve the Data Processing Efficiency in the Fine Focusing

operation.

It should be understood that, for an image, a sharpness value is related to image definition to some extent. By determining sharpness of an image obtained through imaging to obtain a corresponding sharpness value, and then determining a definition score of the image based on the sharpness value, a process of determining the definition score of the image can be simplified, thereby improving the data processing efficiency.

In the present disclosure, the focusing method may include:
evaluating a spot in an image obtained through imaging to determine the definition score.

The focusing method of the present disclosure may be implemented by the microscopy system 1000 of the present disclosure. Specifically, referring to FIG. 3, the control module 210 may be configured for evaluating a spot in an image obtained through imaging to determine the definition score.

In this way, it is beneficial to improve the accuracy of the obtained definition score.

Specifically, after the target surface 101 is imaged, the light rays may form one or more spots in an image obtained through imaging. In some cases, a spot in an image may be determined by detecting a pixel value of the image. In a case, pixel values of all pixel points in an area in which a spot is located are basically consistent, and the pixel values of the area in which the spot is located are greatly different from pixel values of an area (which may also be the entire image) around the spot (generally, the pixel values in the spot are greater than pixel values of other areas in the image). Therefore, a spot in the image may be determined by comparing the pixel values.

It should be understood that the spot in the image has a higher recognition degree than an image area (which may also be the entire image) around the spot. In the case of determining the definition score of the image, the accuracy can be improved to a certain extent by spot-based determination. In some cases, a corresponding light source may be disposed, such that a spot can be formed in an image during imaging, or a spot may be formed through partial overexposure to some extent during imaging.

In addition, it should be noted that in some cases, there may be a problem that a spot cannot be observed on the image. For example, when the image is a high-density array image, the image itself has a high resolution, such that the spot portion in the image has a small display proportion and is difficult to observe; and when the image is an image acquired in a single-target sequencing process, the image itself has no obvious point signal and only a small amount of noise.

In a scenario involving the above image, the present disclosure can determine the definition score of the image in other ways. Specifically, in a case, the grayscale image standard deviation of the image may be acquired or determined and used as the evaluation value of the image sharpness, and then the corresponding area in the image is evaluated according to the grayscale image standard deviation to determine the definition score. In addition, in another case, a pixel standard deviation or a pixel mean value of all pixel points in the image may be acquired or determined, and then the sharpening degrees of the plurality of images are evaluated according to the pixel standard deviation or the pixel mean value to determine the definition score. In this case, the luminance interference can be eliminated.

It should be understood that, for a person skilled in the art, a manner of evaluating the image to determine the definition score in the present disclosure may be selected based on a specific situation of the image.

In the present disclosure, evaluating the spot in the image obtained through imaging can be implemented by the following formula:

Score=[(k1*k2−1)*CV−EV]/[(CV+EV)/(k1*k2)];

where Score represents the definition score, k1*k2 represents a part, within a range of the spot, of a matrix composed of odd-numbered rows and odd-numbered columns in a pixel array of the image, CV represents a central pixel value of the matrix corresponding to the spot, and EV represents a sum of non-central pixel values of the matrix corresponding to the spot.

In this way, the definition score of the image can be conveniently determined by using the spot in the image.

In the present disclosure, the focusing method can be applied in a sequencing-by-synthesis process.

It should be understood that, in general, nucleic acid sequencing includes a process of binding nucleotides (including nucleotide analogs) to a template and acquiring the corresponding extended base fluorescence signal. In some platforms, the binding of nucleotides to the template and the acquisition of corresponding fluorescent signals are performed asynchronously or in real time, and usually multiple rounds of sequencing reactions are required to determine the nucleotide sequence or base sequence of the template nucleic acid molecule. The process of extending one base and determining the type of the extended base can be referred to as a cycle. In other words, in a cycle of sequencing, the process of determining the type of the base at a given position on a template nucleic acid molecule is completed, and this method is also referred to as sequencing by synthesis (SBS).

In the related art, the sequencing sequences or the reads are acquired by performing a plurality of cycles of sequencing using sequencing by synthesis. For example, a target nucleic acid molecule is allowed to be in contact with a polymerase and an altered nucleotide and be subjected to conditions suitable for a polymerization reaction, the altered nucleotide is allowed to be controllably incorporated into the target nucleic acid molecule or a single base extension is controllably achieved, a corresponding reaction signal is detected, the type of the nucleotide incorporated into the target nucleic acid molecule in the reaction is determined based on the signal, and a plurality of controllable single base extensions and detections of corresponding signals are performed to assay the types of the nucleotides or bases incorporated into the target nucleic acid molecule in a plurality of reactions or a plurality of cycles of reactions based on the reaction signal information, thereby assaying and reading a portion of the sequence of the target nucleic acid molecule.

In the sequencing process, in order to make the fluorescent signal correspond to the target nucleic acid molecule, the site where the target nucleic acid is immobilized may be positioned at different coordinates. Specifically, in the sequencing-by-synthesis process, in each extension reaction, the extended base carries an optically detectable label such as a fluorescent label. Therefore, by exciting the fluorescence, at least a portion of the nucleic acid molecule or the clonal cluster can appear as a spot on the image. These “spots” are also referred to as “peaks”, and are presented as light-emitting points on an image. One light-emitting point occupies at least one pixel point. Thus, for a “given position” (also referred to as a “template position”), it will be matched to a particular target nucleic acid molecule or fragment. Thus, the resulting series of image sets can be classified by the position to acquire sequencing reads corresponding to the respective target nucleic acid molecules.

Based on the above, after each round of extension reaction, the excited fluorescence signal is imaged and recorded, such that an image formed by the fluorescence signal can be obtained. These images will reflect the type and intensity of the fluorescence signal at various positions. It should be noted that according to the number of base types added to the reaction mixture in one extension reaction, the image data obtained in each round of extension reaction will be different. Generally, different images can be acquired for fluorescent signals of different colors. In other words, those skilled in the art can understand that after each extension reaction, multiple times of photographing can be performed, and different detection channels can be used for photographing and detection of fluorescence of different colors, such that when the image difference between different detection channels is large, for example, when single-signal sequencing is performed, only one of the plurality of detection channels has a signal, which can ensure to the greatest extent that the degree of fitting between the obtained focal plane and the real focal plane of the objective lens 110 is as large as possible. Therefore, in each cycle of sequencing, in order to determine the type of extended base, at least one image or even a plurality of images need to be acquired. For example, one base extension reaction may include one image acquisition or a plurality of image acquisitions, and a set of these images is used as an image set for subsequent sequencing analysis.

In addition, in some cases, after each extension reaction, the fluorescence of the same color can also be photographed and detected using the same detection channel, and the fine focusing position can be determined based on different positions in the image.

Specifically, in some practical applications, when capturing an image, since the captured image has a large size, or there may be an included angle between the objective lens 110 and the target surface 101 (the included angle may be an included angle formed between the optical axis direction of the objective lens 110 and the normal direction of the target surface 101 due to being non-parallel), a central area and an edge area of the image correspond to different fine focusing positions, or there is a deviation between the optimal focal plane obtained through the central area of the image and the optimal focal plane obtained through the edge area of the image.

For the above problem, to ensure an optimal full-image signal, corresponding fine focusing positions may be acquired for different positions of an image, then a weighted average value is obtained for a plurality of acquired fine focusing positions, and finally the average value is used as a final fine focusing position. In a case, a central area of an image and an edge area between the central area and each of four edges of the image may be selected. A fine focusing operation is performed on a total of five image areas to obtain five fine focusing positions, and then a final fine focusing position is determined based on a weighted average value of the five fine focusing positions.

In addition, the weighted average value of the five fine focusing positions may be a weighted average value of heights formed by the five fine focusing positions along the optical axis, or may be a weighted average value of the magnitudes of electrical signals respectively corresponding to the five fine focusing positions acquired by the automatic focusing assembly. When the weighted average value processing is performed on the five fine focusing positions, a weight of each image area may be determined based on an actual situation of the image (e.g., a specific part of the image is not clear enough due to a device problem), or may be calibrated through an actual test. In other cases, the specific position and number of selected image areas may also be adjusted and determined as appropriate.

Referring to FIG. 11, the focusing method may include:
03: controlling the microscopy system 1000 to sequentially perform one coarse focusing operation and one fine focusing operation during a first round of base extension reaction; and
04: controlling the microscopy system 1000 to perform one fine focusing operation during each round of base extension reaction after the first round of base extension reaction.

The focusing method of the present disclosure may be implemented by the microscopy system 1000 of the present disclosure. Specifically, referring to FIG. 3, the control module 210 may be configured for: controlling the microscopy system 1000 to sequentially perform one coarse focusing operation and one fine focusing operation during a first round of base extension reaction; and controlling the microscopy system 1000 to perform one fine focusing operation during each round of base extension reaction after the first round of base extension reaction.

In this way, rapid focusing in the sequencing-by-synthesis process can be achieved.

It should be understood that in the sequencing-by-synthesis process, since a plurality of base extension reactions need to be performed, and the sequencing sample needs to be imaged after each base extension reaction to determine whether the base extension reaction is performed as expected, it is necessary to perform a focusing operation after each base extension reaction to ensure that the captured test sample is clear enough.

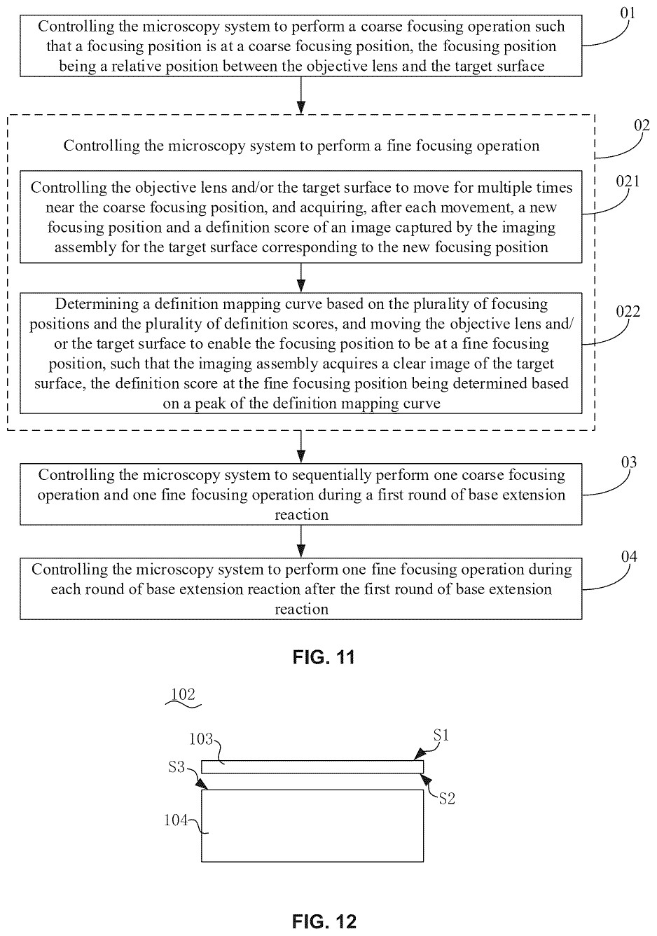

The sequencing sample may be located on a sequencing chip, and the target surface 101 may be a surface on which a sequencing reaction occurs in the sequencing chip. Referring to FIG. 12, FIG. 12 shows a sequencing chip 102 used in a sequencing-by-synthesis process. The sequencing chip 102 may include a first glass plate 103 and a second glass plate 104. In FIG. 12, the upper surface of the first glass plate 103 may be denoted as S1, the lower surface of the first glass plate 103 may be denoted as S2, and the upper surface of the second glass plate 104 may be denoted as S3. A gap is formed between the lower surface of the first glass plate 103 and the upper surface of the second glass plate 104, and the gap is a fluid channel of the sequencing chip 102.

In some cases, in the flow of a sequencing reaction, the lower surface S2 of the first glass plate 103 may be subjected to special chemical modification. The surface of the first glass plate may be connected to an oligonucleotide sequence via hydrogen bonds, and the oligonucleotide sequence may be complementary hybridized with a linker sequence of single-stranded DNA or RNA, such that the test sample is defined on the lower surface S2 of the first glass plate 103, and then the lower surface S2 of the first glass plate 103 may be used as the target surface 101 of the present disclosure. Similarly, in some other cases, the upper surface S3 of the second glass plate 104 may also be subjected to special chemical modification, such that the upper surface S3 of the second glass plate 104 may also serve as the target surface 101 of the present disclosure.

In addition, since the microscopy system 1000 is controlled to perform one coarse focusing operation and one fine focusing operation in sequence during the first round of base extension reaction, such that the target surface 101 is sufficiently close to the focal plane of the objective lens 110, it is not necessary to perform the coarse focusing operation during each round of base extension reaction after the first round of base extension reaction, but only the fine focusing operation can be performed, which is beneficial to improve the processing speed of the overall process of sequencing-by-synthesis, thereby improving the sequencing efficiency.

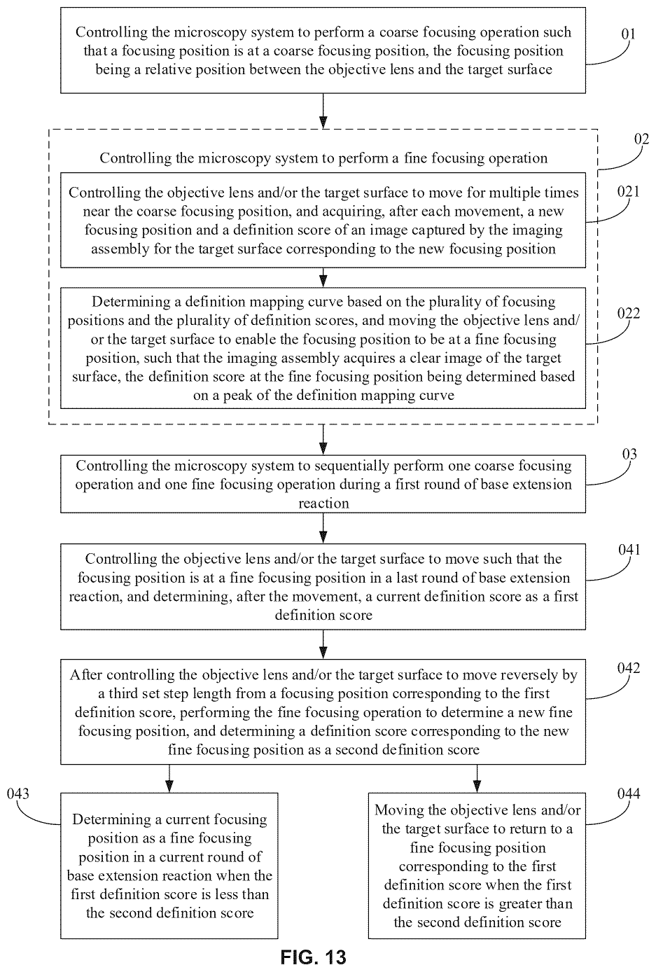

Referring to FIG. 13, in the present disclosure, the step 04 (controlling the microscopy system 1000 to perform one fine focusing operation during each round of base extension reaction after the first round of base extension reaction) may include:
041: controlling the objective lens 110 and/or the target surface 101 to move such that the focusing position is at a fine focusing position in a last round of base extension reaction, and determining, after the movement, a current definition score as a first definition score;
042: after controlling the objective lens 110 and/or the target surface 101 to move reversely by a third set step length from a focusing position corresponding to the first definition score, performing the fine focusing operation to determine a new fine focusing position, and determining a definition score corresponding to the new fine focusing position as a second definition score;
043: determining a current focusing position as a fine focusing position in a current round of base extension reaction when the first definition score is less than the second definition score; and
044: moving the objective lens 110 and/or the target surface 101 to return to a fine focusing position corresponding to the first definition score when the first definition score is greater than the second definition score.

The focusing method of the present disclosure may be implemented by the microscopy system 1000 of the present disclosure. Specifically, referring to FIG. 3, the control module 210 may be configured for: controlling the objective lens 110 and/or the target surface 101 to move such that the focusing position is at a fine focusing position in a last round of base extension reaction, and determining, after the movement, a current definition score as a first definition score; after controlling the objective lens 110 and/or the target surface 101 to move reversely by a third set step length from a focusing position corresponding to the first definition score, performing the fine focusing operation to determine a new fine focusing position, and determining a definition score corresponding to the new fine focusing position as a second definition score; determining a current focusing position as a fine focusing position in a current round of base extension reaction when the first definition score is less than the second definition score; and moving the objective lens 110 and/or the target surface 101 to return to a fine focusing position corresponding to the first definition score when the first definition score is greater than the second definition score.

In this way, it can be ensured that the target surface 101 is imaged as clearly as possible.

It should be understood that in the sequencing-by-synthesis process, since the target surface 101 needs to be imaged once after each round of base extension reaction, focusing needs to be performed during each imaging, such that the focusing position is at the fine focusing position under the current round of base extension reaction, thereby ensuring that the imaging of the target surface 101 under each round of base extension reaction is as clear as possible.

Specifically, in the case of performing at least two rounds of base extension reactions, since the focal plane of the objective lens 110 is focused during the last round of base extension reaction, when a new round of base extension reaction is performed, the fine focusing position in the last round of base extension reaction may be first used as an initial focusing position, and then a fine focusing operation is performed at the third set step length from the initial focusing position to obtain a new fine focusing position. Further, the definition scores respectively corresponding to the previous and next fine focusing positions are compared. If the definition score of the initial focusing position is greater, the fine focusing position in the last round of base extension reaction is used as the fine focusing position in the current round of base extension reaction; and if the definition score of the new focusing position is greater, the new fine focusing position is used as the fine focusing position in the current round of base extension reaction.

In addition, in some cases, the step 041 and the step 042 may be to control the objective lens 110 and/or the target surface 101 to move along the positive direction of the Z-axis such that the focusing position is at the fine focusing position in the last round of base extension reaction, and then to move by a third set step length along the negative direction of the Z-axis. In some other cases, the step 041 and the step 042 may be to control the objective lens 110 and/or the target surface 101 to move along the negative direction of the Z-axis such that the focusing position is at the fine focusing position in the last round of base extension reaction, and then to move by a third set step length along the positive direction of the Z-axis. A specific moving manner may be selected based on an actual application scenario.

In the present disclosure, the focusing method may include:

When the focusing position in the last round of base extension reaction is not at the fine focusing position, the microscopy system 1000 is controlled to perform one coarse focusing operation, and after the coarse focusing operation is completed, the objective lens 110 and/or the target surface 101 is controlled to move to determine the second definition score.

The focusing method of the present disclosure may be implemented by the microscopy system 1000 of the present disclosure. Specifically, referring to FIG. 3, the control module 210 may be configured for controlling the microscopy system 1000 to perform one coarse focusing operation when a focusing position in the last round of base extension reaction is not at the fine focusing position, and controlling, after the coarse focusing operation is completed, the objective lens 110 and/or the target surface 101 to move to determine the second definition score.

In this way, the focusing accuracy of the current round of base extension reaction can be ensured.

It should be understood that if the focusing position in the last round of base extension reaction is not at the fine focusing position, it indicates that the focusing operation performed in the last round of base extension reaction is not successful and is not suitable as a reference for the fine focusing position in the current round of base extension reaction.

Specifically, if the last round of fine focusing operation is unsuccessful, the first definition score may not be obtained. At this time, one coarse focusing operation may be performed to ensure that the focusing position can reach the vicinity of the focal plane, and then a fine focusing operation is performed to ensure that the focusing position corresponding to the obtained second definition score is as close to the focal plane as possible, thereby ensuring the focusing accuracy of the current round of base extension reaction.

Referring to FIG. 3, in the present disclosure, the microscopy system 1000 may include a driving assembly 300. The driving assembly 300 may be configured for driving the objective lens 110 and/or the target surface 101 to move along the optical axis of the objective lens 110.

In the present disclosure, the focusing method may include: after determining the first definition score, detecting whether a difference value between a first voltage value and a second voltage value is less than or equal to a first set value, where the first voltage value is a voltage value output when the objective lens 110 and/or the target surface 101 is controlled by the driving assembly 300 to move to a focusing position corresponding to the first definition score in the last round of base extension reaction, and the second voltage value is a voltage value output when the objective lens 110 and/or the target surface 101 is controlled by the driving assembly 300 to move to a focusing position corresponding to the first definition score in the current round of base extension reaction; controlling the objective lens 110 and/or the target surface 101 to move to determine the second definition score when the difference value is less than or equal to the first set value; and controlling the microscopy system 1000 to perform one coarse focusing operation when the difference value is greater than the first set value, and after the coarse focusing operation is completed, controlling the objective lens 110 and/or the target surface 101 to move to determine the second definition score.

The focusing method of the present disclosure may be implemented by the microscopy system 1000 of the present disclosure. Specifically, referring to FIG. 3, the control module 210 may be configured for: after determining the first definition score, detecting whether a difference value between a first voltage value and a second voltage value is less than or equal to a first set value, where the first voltage value is a voltage value output when the objective lens 110 and/or the target surface 101 is controlled by the driving assembly 300 to move to a focusing position corresponding to the first definition score in the last round of base extension reaction, and the second voltage value is a voltage value output when the objective lens 110 and/or the target surface 101 is controlled by the driving assembly 300 to move to a focusing position corresponding to the first definition score in the current round of base extension reaction; controlling the objective lens 110 and/or the target surface 101 to move to determine the second definition score when the difference value is less than or equal to the first set value; and controlling the microscopy system 1000 to perform one coarse focusing operation when the difference value is greater than the first set value, and after the coarse focusing operation is completed, controlling the objective lens 110 and/or the target surface 101 to move to determine the second definition score.

In this way, whether the obtained definition score is affected by fluctuation can be determined.

Specifically, the magnitude of the voltage value output by the driving assembly 300 can correspond to the magnitude of the distance between the target surface 101 in the focusing position and the focal plane. In other words, for the previous and next fine focusing operations, if the two fine focusing operations have the same focusing position, the driving assembly 300 may also output the same voltage value.

Based on the above, when the fine focusing operation is performed in combination with the fine focusing position in the last round of base extension reaction, according to the difference value between the first voltage value and the second voltage value, it can be determined how much deviation exists between the new fine focusing position in the current round of base extension reaction and the fine focusing position in the last round of base extension reaction. If the difference value is less than or equal to the first set value, it indicates that the deviation is in an acceptable range, and substantially the same clarity as the image obtained through imaging in the last round of base extension reaction can be maintained; and if the difference value is greater than the first set value, it indicates that the obtained second voltage value has an abnormal fluctuation, such that the microscopy system 1000 can be controlled to perform one coarse focusing operation to eliminate the abnormal fluctuation in the second voltage value.

In addition, in some cases, the first set value may be determined based on an actual situation, or may be calibrated through a test.

In the present disclosure, the step 042 (after controlling the objective lens 110 and/or the target surface 101 to move reversely by a third set step length from a focusing position corresponding to the first definition score, performing the fine focusing operation to determine a new fine focusing position, and determining a definition score corresponding to the new fine focusing position as a second definition score) may include:
acquiring a third voltage value, where the third voltage value is a voltage value output when the objective lens 110 and/or the target surface 101 is controlled by the driving assembly 300 to move to the corresponding new fine focusing position in the current round of base extension reaction;
determining the definition score corresponding to the new fine focusing position as the second definition score when the third voltage value is less than a second set value; and
performing voltage zeroing processing on the driving assembly 300 when the third voltage value is greater than or equal to the second set value, controlling the objective lens 110 and/or the target surface 101 to move reversely by the third set step length again from the focusing position corresponding to the first definition score, and re-performing the fine focusing operation until the obtained third voltage value is less than the second set value.

The focusing method of the present disclosure may be implemented by the microscopy system 1000 of the present disclosure. Specifically, referring to FIG. 3, the control module 210 may be configured for: acquiring a third voltage value, where the third voltage value is a voltage value output when the objective lens 110 and/or the target surface 101 is controlled by the driving assembly 300 to move to the corresponding new fine focusing position in the current round of base extension reaction; determining the definition score corresponding to the new fine focusing position as the second definition score when the third voltage value is less than a second set value; and performing voltage zeroing processing on the driving assembly 300 when the third voltage value is greater than or equal to the second set value, controlling the objective lens 110 and/or the target surface 101 to move reversely by the third set step length again from the focusing position corresponding to the first definition score, and re-performing the fine focusing operation until the obtained third voltage value is less than the second set value.

In this way, it is possible to avoid an increase in the voltage value from affecting the accuracy of the fine focusing operation.

Specifically, in some cases, the magnitude of the voltage value output by the driving assembly 300 is positively correlated with the magnitude of the distance between the target surface 101 in the focusing position and the focal plane. When the third voltage value is greater than or equal to the second set value, the distance between the target surface 101 in the focusing position and the focal plane of the objective lens 110 is relatively large, and at this time, the movement of a small distance is not easy to be detected, such that there is a certain deviation between the output third voltage value and the actual voltage value that should be output, and the subsequent fine focusing operation may lead to inaccurate focusing.

Based on the above, the driving assembly 300 may be subjected to voltage zeroing processing, and the voltage value output by the driving assembly 300 may be reset. In this way, when a subsequent fine focusing operation is performed, the third voltage value is basically close to a reference value (e.g., 0). In this case, a distance change formed by a focusing position can be reflected by the third voltage value, thereby ensuring the focusing accuracy in the subsequent fine focusing operation.

In addition, in some cases, the second set value may be determined based on an actual situation, or may be calibrated through a test.

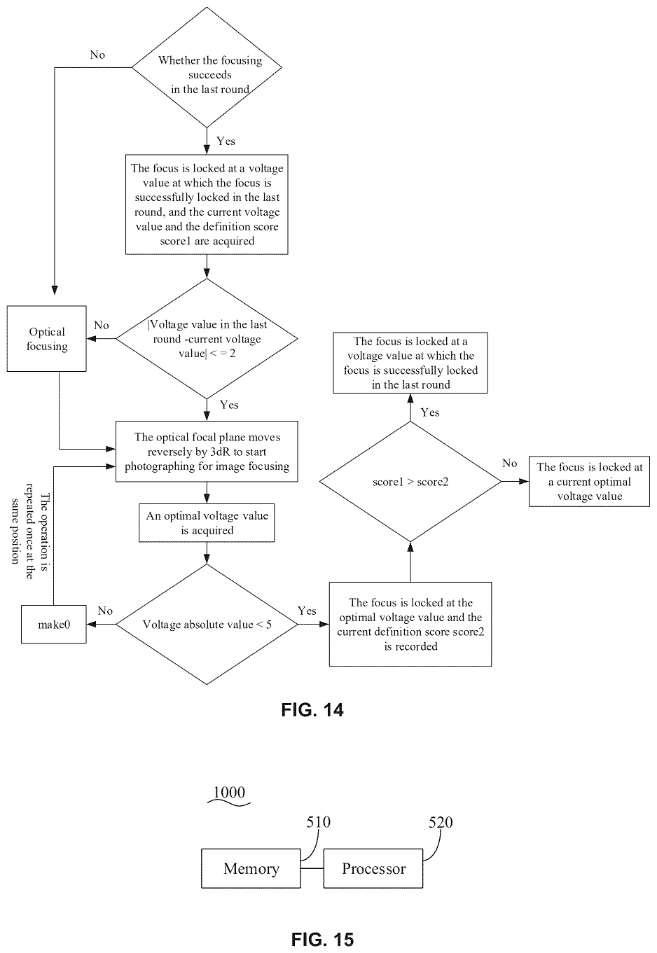

Referring to FIG. 14, in an application scenario of the present disclosure, when a new round of base extension reaction is performed, whether the focusing succeeds in the last round of base extension reaction may be determined. If the focusing succeeds in the last round of base extension reaction, the focus is locked according to the voltage value at which the focus is successfully locked in the last round of base extension reaction, and then the current voltage value and the definition score score1 are acquired. If the focusing fails in the last round of base extension reaction, optical focusing is performed with a coarse focusing operation. After score1 is obtained, it can be detected whether the absolute value of the difference value between the voltage value in the last round of base extension reaction and the current voltage value is less than 2. If yes, the focal plane of the objective lens 110 starts to move reversely by a step length of 3dR and starts photographing and focusing, and if no, optical focusing is also performed with a coarse focusing operation. After a plurality of images are obtained by photographing and focusing, one of voltage values corresponding to all the images is acquired as an optimal voltage value, and whether the optimal voltage value is less than 5 is determined. If yes, the focus is locked by using the optimal voltage value, and a definition score score2 is acquired after the focus is locked. If no, make0 (zero clearing) processing is performed, and then a fine focusing operation is performed again from a focusing position before the optical focal plane moves reversely, a new optimal voltage value is acquired, and whether the optimal voltage value is less than 5 is determined. After score2 is determined, the value between score 1 and score2 is determined. If score1 is greater than score2, the focus is locked according to the voltage value at which the focus is successfully locked in the last round of base extension reaction; and if score1 is less than score2, the focus is locked according to the optimal voltage value obtained in the current round of base extension reaction.

Referring to FIG. 15, the microscopy system 1000 of the present disclosure may include a memory 510 and a processor 520. The memory 510 may store a computer program. The processor 520, when executing the computer program, may implement the steps of the focusing method according to the present disclosure.

For example, the step that the computer program, when executed by a processor, causes the processor to implement the focusing method may include:
01: controlling the microscopy system 1000 to perform a coarse focusing operation such that a focusing position is at a coarse focusing position, the focusing position being a relative position between the objective lens 110 and the target surface 101; and
02: controlling the microscopy system 1000 to perform a fine focusing operation, including:
021: controlling the objective lens 110 and/or the target surface 101 to move for multiple times near the coarse focusing position, and acquiring, after each movement, a new focusing position and a definition score of an image captured by the imaging assembly 120 for the target surface 101 corresponding to the new focusing position; and
022: determining a definition mapping curve based on the plurality of focusing positions and the plurality of definition scores, and moving the objective lens 110 and/or the target surface 101 to enable the focusing position to be at a fine focusing position, such that the imaging assembly 120 acquires a clear image of the target surface 101, the definition score at the fine focusing position being determined based on a peak of the definition mapping curve.

In the microscopy system 1000 described above, by moving the objective lens 110 and/or the target surface 101, a new focusing position and a corresponding definition score are obtained, and then a plurality of focusing positions and a plurality of definition scores are obtained. The plurality of definition scores can be used to determine a definition mapping curve. The focusing position corresponding to the peak of the definition mapping curve can enable the imaging assembly 120 to acquire the clearest image, so that the focusing operation of the microscopy system 1000 can be controlled by the change condition of the definition score, thereby achieving an automatic focusing effect, making the focusing more accurate and faster, and improving the observation efficiency.

Referring to FIG. 15, provided is a computer-readable storage medium having a computer program stored thereon. The computer program, when executed by a processor 520, may cause the processor 520 to implement the steps of the focusing method according to the present disclosure.

For example, the step that the computer program, when executed by a processor, causes the processor to implement the focusing method may include:
01: controlling the microscopy system 1000 to perform a coarse focusing operation such that a focusing position is at a coarse focusing position, the focusing position being a relative position between the objective lens 110 and the target surface 101; and
02: controlling the microscopy system 1000 to perform a fine focusing operation, including:
021: controlling the objective lens 110 and/or the target surface 101 to move for multiple times near the coarse focusing position, and acquiring, after each movement, a new focusing position and a definition score of an image captured by the imaging assembly 120 for the target surface 101 corresponding to the new focusing position; and
022: determining a definition mapping curve based on the plurality of focusing positions and the plurality of definition scores, and moving the objective lens 110 and/or the target surface 101 to enable the focusing position to be at a fine focusing position, such that the imaging assembly 120 acquires a clear image of the target surface 101, the definition score at the fine focusing position being determined based on a peak of the definition mapping curve.

In the microscopy system 1000 described above, by moving the objective lens 110 and/or the target surface 101, a new focusing position and a corresponding definition score are obtained, and then a plurality of focusing positions and a plurality of definition scores are obtained. The plurality of definition scores can be used to determine a definition mapping curve. The focusing position corresponding to the peak of the definition mapping curve can enable the imaging assembly 120 to acquire the clearest image, so that the focusing operation of the microscopy system 1000 can be controlled by the change condition of the definition score, thereby achieving an automatic focusing effect, making the focusing more accurate and faster, and improving the observation efficiency.

The computer-readable storage medium may be provided in the microscopy system 1000 or in other terminals, and the microscopy system 1000 can communicate with other terminals to obtain corresponding programs.

It should be understood that the computer-readable storage medium may include any entity or apparatus capable of carrying a computer program, a recording medium, a USB flash disk, a mobile hard disk, a magnetic disk, an optical disc, a computer memory, a read-only memory (ROM), a random access memory (RAM), a software distribution medium, etc. The computer program may include computer program codes. The computer program codes may be in a source code form, an object code form, an executable file, some intermediate forms, or the like.

In some embodiments of the present disclosure, the control module 210 may be a single-chip microcomputer chip that integrates a processor, a memory, a communication module, etc. The processor may be a central processing unit (CPU), may be a graphics processing unit (GPU), or may be another general-purpose processor, a digital signal processor (DSP), an application-specific integrated circuit (ASIC), a field-programmable gate array (FPGA) or another programmable logic device, a discrete gate or transistor logic device, a discrete hardware component, etc.

Any process or method in the flowchart or otherwise described herein should be understood as representing a module, segment or portion of code including one or more executable instructions for implementing steps of specific logical functions or processes, and the scope of preferred embodiments of the present disclosure includes additional implementations, in which functions can be performed not in the order shown or discussed, including in a substantially simultaneous manner or in the reverse order, depending on the function involved, as should be understood by those skilled in the art to which embodiments of the present disclosure belong.

Logic and/or steps shown in the flowcharts or described herein in other manners, for example, may be considered as a program list of executable instructions that are configured to implement logical functions, and may be specifically implemented on any computer-readable medium, for use by an instruction execution system, apparatus, or device (for example, a computer-based system, a system including a processor module, or another system that can fetch instructions from the instruction execution system, apparatus, or device and execute the instructions), or for use in combination with the instruction execution system, apparatus, or device.

Although the embodiments of the present disclosure have been illustrated and described, it can be understood by those of ordinary skill in the art that various changes, modifications, replacements, and variations can be made to these embodiments of the present disclosure without departing from the principle and purpose of the present disclosure, and the scope of the present disclosure is defined by the claims and equivalents therefore.

What is claimed is:

1. A focusing method, applied to a microscopy system, wherein the microscopy system comprises an objective lens and an imaging assembly for imaging a target surface, and the focusing method comprises:
controlling the microscopy system to perform a coarse focusing operation such that a focusing position is at a coarse focusing position, the focusing position being a relative position between the objective lens and the target surface; and
controlling the microscopy system to perform a fine focusing operation, comprising:
controlling the objective lens and/or the target surface to move for multiple times near the coarse focusing position, and acquiring, after each movement, a new focusing position and a definition score of an image captured by the imaging assembly for the target surface corresponding to the new focusing position; and
determining a definition mapping curve based on the plurality of focusing positions and the plurality of definition scores, and moving the objective lens and/or the target surface to enable the focusing position to be at a fine focusing position, such that the imaging assembly acquires a clear image of the target surface, the definition score at the fine focusing position being determined based on a peak of the definition mapping curve.

2. The focusing method according to claim 1, wherein the step of controlling the objective lens and/or the target surface to move for multiple times near the coarse focusing position, and acquiring, after each movement, the new focusing position and the definition score of the image captured by the imaging assembly for the target surface corresponding to the new focusing position comprises:
controlling the objective lens and/or the target surface to move by a first set distance from the coarse focusing position, and controlling the objective lens and/or the target surface to move by a second set step length for multiple times in an opposite direction.

3. The focusing method according to claim 2, wherein the microscopy system comprises an automatic focusing assembly, and the focusing method comprises:
controlling the automatic focusing assembly to send a second focusing light ray to the target surface along an optical axis of the objective lens, receiving the second focusing light ray reflected by the target surface, and outputting an electrical signal according to the received second focusing light ray, the electrical signal being related to the focusing position; and
the step of controlling the objective lens and/or the target surface to move for multiple times near the coarse focusing position, and acquiring, after each movement, the new focusing position and the definition score of the image captured by the imaging assembly for the target surface corresponding to the new focusing position comprises:
controlling the objective lens and/or the target surface to move according to the electrical signal.

4. The focusing method according to claim 1, wherein the step of determining the definition mapping curve based on the plurality of focusing positions and the plurality of definition scores, and moving the objective lens and/or the target surface to enable the focusing position to be at the fine focusing position comprises:
fitting the plurality of focusing positions and the plurality of definition scores to obtain the definition mapping curve; and
controlling the objective lens and/or the target surface to move such that the focusing position is at the fine focusing position.

5. The focusing method according to claim 4, wherein the step of fitting the plurality of focusing positions and the plurality of definition scores to obtain the definition mapping curve comprises:
determining to control the microscopy system to re-perform the coarse focusing operation and/or the fine focusing operation when the definition mapping curve meets a set condition;
wherein the set condition comprises at least one of the following:
when a number of the plurality of definition scores is greater than a set number, the peak of the definition mapping curve still cannot be fitted;
when the objective lens and/or the target surface moves to a maximum scanning distance, the peak of the definition mapping curve still cannot be fitted;
the plurality of definition scores obtained in sequence have a gradually decreasing trend;
a fluctuation amplitude of the definition mapping curve is less than a set amplitude value, and a maximum value of the definition score is less than a set score; and
the definition mapping curve has a plurality of peaks.

6. The focusing method according to claim 1, wherein the focusing method is applied in a sequencing-by-synthesis process, and the focusing method comprises:
controlling the microscopy system to sequentially perform one coarse focusing operation and one fine focusing operation during a first round of base extension reaction; and
controlling the microscopy system to perform one fine focusing operation during each round of base extension reaction after the first round of base extension reaction.

7. The focusing method according to claim 6, wherein the step of controlling the microscopy system to perform one fine focusing operation during each round of base extension reaction after the first round of base extension reaction comprises:
controlling the objective lens and/or the target surface to move such that the focusing position is at a fine focusing position in a last round of base extension reaction, and determining, after the movement, a current definition score as a first definition score;
after controlling the objective lens and/or the target surface to move reversely by a third set step length from a focusing position corresponding to the first definition score, performing the fine focusing operation to determine a new fine focusing position, and determining a definition score corresponding to the new fine focusing position as a second definition score;
determining a current focusing position as a fine focusing position in a current round of base extension reaction when the first definition score is less than the second definition score; and
moving the objective lens and/or the target surface to return to a fine focusing position corresponding to the first definition score when the first definition score is greater than the second definition score.

8. The focusing method according to claim 7, wherein the microscopic system comprises a driving assembly configured for driving the objective lens and/or the target surface to move along an optical axis of the objective lens; and
the focusing method comprises:
after determining the first definition score, detecting whether a difference value between a first voltage value and a second voltage value is less than or equal to a first set value, wherein the first voltage value is a voltage value output when the objective lens and/or the target surface is controlled by the driving assembly to move to a focusing position corresponding to the first definition score in the last round of base extension reaction, and the second voltage value is a voltage value output when the objective lens and/or the target surface is controlled by the driving assembly to move to a focusing position corresponding to the first definition score in the current round of base extension reaction;
controlling the objective lens and/or the target surface to move to determine the second definition score when the difference value is less than or equal to the first set value; and
controlling the microscopy system to perform one coarse focusing operation when the difference value is greater than the first set value, and after the coarse focusing operation is completed, controlling the objective lens and/or the target surface to move to determine the second definition score.

9. The focusing method according to claim 8, wherein the step of after controlling the objective lens and/or the target surface to move reversely by the third set step length from the focusing position corresponding to the first definition score, performing the fine focusing operation to determine the new fine focusing position, and determining the definition score corresponding to the new fine focusing position as the second definition score comprises:
acquiring a third voltage value, wherein the third voltage value is a voltage value output when the objective lens and/or the target surface is controlled by the driving assembly to move to the corresponding new fine focusing position in the current round of base extension reaction;
determining the definition score corresponding to the new fine focusing position as the second definition score when the third voltage value is less than a second set value; and
performing voltage zeroing processing on the driving assembly when the third voltage value is greater than or equal to the second set value, controlling the objective lens and/or the target surface to move reversely by the third set step length again from the focusing position corresponding to the first definition score, and re-performing the fine focusing operation until the obtained third voltage value is less than the second set value.

10. A microscopy system, wherein the microscopy system comprises an objective lens, an imaging assembly for imaging a target surface, and a control module, the control module being configured for:
controlling the microscopy system to perform a coarse focusing operation such that a focusing position is at a coarse focusing position, the focusing position being a relative position between the objective lens and the target surface; and
controlling the microscopy system to perform a fine focusing operation, comprising:
controlling the objective lens and/or the target surface to move for multiple times near the coarse focusing position, and acquiring, after each movement, a new focusing position and a definition score of an image captured by the imaging assembly for the target surface corresponding to the new focusing position; and
determining a definition mapping curve based on the plurality of focusing positions and the plurality of definition scores, and moving the objective lens and/or the target surface to enable the focusing position to be at a fine focusing position, such that the imaging assembly acquires a clear image of the target surface, the definition score at the fine focusing position being determined based on a peak of the definition mapping curve.

11. The microscopy system according to claim 10, wherein the control module is configured for:
controlling the objective lens and/or the target surface to move by a first set distance from the coarse focusing position, and controlling the objective lens and/or the target surface to move by a second set step length for multiple times in an opposite direction.

12. The microscopy system according to claim 11, wherein the microscopy system comprises an automatic focusing assembly, and the control module is configured for:
controlling the automatic focusing assembly to send a second focusing light ray to the target surface along an optical axis of the objective lens, receiving the second focusing light ray reflected by the target surface, and outputting an electrical signal according to the received second focusing light ray, the electrical signal being related to the focusing position; and
controlling the objective lens and/or the target surface to move according to the electrical signal.

13. The microscopy system according to claim 10, wherein the control module is configured for:
fitting the plurality of focusing positions and the plurality of definition scores to obtain the definition mapping curve; and
controlling the objective lens and/or the target surface to move such that the focusing position is at the fine focusing position.

14. The microscopy system according to claim 13, wherein the control module is configured for:
determining to control the microscopy system to re-perform the coarse focusing operation and/or the fine focusing operation when the definition mapping curve meets a set condition;
wherein the set condition comprises at least one of the following:
when a number of the plurality of definition scores is greater than a set number, the peak of the definition mapping curve still cannot be fitted;
when the objective lens and/or the target surface moves to a maximum scanning distance, the peak of the definition mapping curve still cannot be fitted;
the plurality of definition scores obtained in sequence have a gradually decreasing trend;
a fluctuation amplitude of the definition mapping curve is less than a set amplitude value, and a maximum value of the definition score is less than a set score; and
the definition mapping curve has a plurality of peaks.

15. The microscopy system according to claim 10, wherein the microscopy system is applied in a sequencing-by-synthesis process, and the control module is configured for:
controlling the microscopy system to sequentially perform one coarse focusing operation and one fine focusing operation during a first round of base extension reaction; and
controlling the microscopy system to perform one fine focusing operation during each round of base extension reaction after the first round of base extension reaction.

16. The microscopy system according to claim 15, wherein the control module is configured for:
controlling the objective lens and/or the target surface to move such that the focusing position is at a fine focusing position in a last round of base extension reaction, and determining, after the movement, a current definition score as a first definition score;
after controlling the objective lens and/or the target surface to move reversely by a third set step length from a focusing position corresponding to the first definition score, performing the fine focusing operation to determine a new fine focusing position, and determining a definition score corresponding to the new fine focusing position as a second definition score;
determining a current focusing position as a fine focusing position in a current round of base extension reaction when the first definition score is less than the second definition score; and
moving the objective lens and/or the target surface to return to a fine focusing position corresponding to the first definition score when the first definition score is greater than the second definition score.

17. The microscopy system according to claim 16, wherein the microscopic system comprises a driving assembly configured for driving the objective lens and/or the target surface to move along an optical axis of the objective lens; and
the control module is configured for:
after determining the first definition score, detecting whether a difference value between a first voltage value and a second voltage value is less than or equal to a first set value, wherein the first voltage value is a voltage value output when the objective lens and/or the target surface is controlled by the driving assembly to move to a focusing position corresponding to the first definition score in the last round of base extension reaction, and the second voltage value is a voltage value output when the objective lens and/or the target surface is controlled by the driving assembly to move to a focusing position corresponding to the first definition score in the current round of base extension reaction;
controlling the objective lens and/or the target surface to move to determine the second definition score when the difference value is less than or equal to the first set value; and
controlling the microscopy system to perform one coarse focusing operation when the difference value is greater than the first set value, and after the coarse focusing operation is completed, controlling the objective lens and/or the target surface to move to determine the second definition score.

18. The microscopy system according to claim 17, wherein the control module is configured for:
acquiring a third voltage value, wherein the third voltage value is a voltage value output when the objective lens and/or the target surface is controlled by the driving assembly to move to the corresponding new fine focusing position in the current round of base extension reaction;
determining the definition score corresponding to the new fine focusing position as the second definition score when the third voltage value is less than a second set value; and
performing voltage zeroing processing on the driving assembly when the third voltage value is greater than or equal to the second set value, controlling the objective lens and/or the target surface to move reversely by the third set step length again from the focusing position corresponding to the first definition score, and re-performing the fine focusing operation until the obtained third voltage value is less than the second set value.

19. A microscopy system, comprising a memory and a processor, wherein the memory stores a computer program, and the processor, when executing the computer program, implements the steps of the focusing method according to claim 1.

20. A computer-readable storage medium having a computer program stored thereon, wherein the computer program, when executed by a processor, causes the processor to implement the steps of the focusing method according to claim 1.
